(19) United States
(12) Patent Application Publication
(10) Pub. No.: US 2018/0114171 A1
(43) Pub. Date: Apr. 26, 2018

(54) APPARATUS AND METHOD FOR PREDICTING EXPECTED SUCCESS RATE FOR A BUSINESS ENTITY USING A MACHINE LEARNING MODULE

(71) Applicant: AINGEL CORP., Cupertino, CA (US)

(72) Inventor: Amr Shady, Cupertino, CA (US)

(73) Assignee: AINGEL Corp.

(21) Appl. No.: 15/332,848

(22) Filed: Oct. 24, 2016

(51) Int. Cl. G06Q 10/06; G06N 99/00; G06N 5/02

(52) U.S. Cl. CPC G06Q 10/06375; G06N 5/022; G06N 99/005

(57) ABSTRACT

An apparatus and method is described for predicting the expected success rate for an organization, such as a technology startup business, using a prediction engine that configures a plurality of machine learning algorithms using a training dataset and a testing dataset and generates an expected success rate for an organization using an input data set and the configured machine learning algorithms.

### TECHNICAL FIELD

An apparatus and method is described for predicting the expected success rate for an organization, such as a technology startup business, using a prediction engine that configures a plurality of machine learning algorithms using a training dataset and a testing dataset and generates an expected success rate for an organization using an input data set and the configured machine learning algorithms.

### BACKGROUND OF THE INVENTION

Predicting the chances of success of a new business venture is a difficult exercise that often entails guesswork and a great deal of subjectivity. There are many factors, some known and some unknown, that affect the eventual degree of success of a new business venture, such as the experience of the founders, the personality traits of the founders, whether the venture has raised capital, and the amount of capital raised. There are dozens of other factors, perhaps hundreds.

It is impossible for a human being to consider all of the possible factors, to determine how strongly each one correlates to eventual success, to identify the degree of importance of each factor, and to arrive at a quantitative assessment of the venture's expected success rate. This makes it particularly difficult for potential investors to decide whether or not to invest in the venture.

The prior art includes machine learning devices. Machine learning allows a computing device to run one or more learning algorithms based on an input data set and to run multiple iterations of each algorithm upon the data. To date, machine learning has not been utilized to determine the likelihood of success of a business venture.

What is needed is a computing device that utilizes machine learning to generate an expected success rate for a particular business venture. What is further needed is to the ability to compare that expected success rate to the expected success rates of established companies when those companies were at the same stage as the particular business venture.

### SUMMARY OF THE INVENTION

The embodiments described herein include a computing device comprising a background analysis engine, a prediction engine, and a display engine. The background analysis engine receives raw data regarding a particular business venture and operates a data acquisition module to obtain additional data regarding the business venture on the Internet. The prediction engine comprises a machine learning module that operates a plurality of machine learning algorithms that are configured using a training dataset and a testing dataset comprising data from known companies. The machine learning module then applies the plurality of machine learning algorithms to the data generated by the background analysis engine regarding the business venture. The display engine generates reports for a user that conveys data generated by the machine learning module, including the expected success rate of the business venture.

### BRIEF DESCRIPTION OF THE DRAWINGS

FIG. 1 depicts hardware components of a computing device and data store.

FIG. 2 depicts software components of the computing device.

FIG. 3 depicts a background analysis engine receiving company raw data and outputting a company dataset.

FIG. 4 depicts a model building process for a machine learning engine.

FIG. 5 depicts a testing process for a machine learning engine.

FIG. 6 depicts the creation of a plurality of merged datasets, each created from the company dataset and a subset of the testing dataset.

FIG. 7 depicts a prediction engine that operates on the plurality of merged datasets.

FIG. 8 depicts the output of the prediction engine.

FIG. 9 depicts the generation of an expected success rate for a business venture.

FIG. 10 depicts an exemplary report generated by a display engine.

FIG. 11 depicts another exemplary report generated by the display engine.

### DETAILED DESCRIPTION OF THE PREFERRED EMBODIMENTS

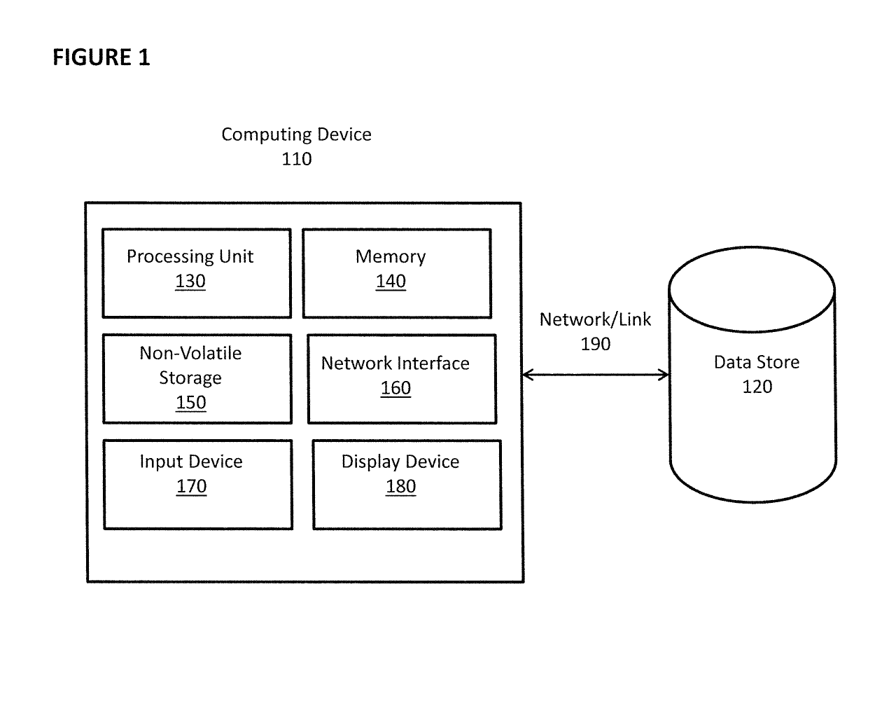

With reference to FIG. 1, computing device 110 is depicted. Computing device 110 can be a server, desktop, notebook, mobile device, tablet, or any other computer with network connectivity. Computing device 110 comprises processing unit 130, memory 140, non-volatile storage 150, network interface 160, input device 170, and display device 180. Non-volatile storage 150 can comprise a hard disk drive or solid state drive. Network interface 160 can comprise an interface for wired communication (e.g., Ethernet) or wireless communication (e.g., 3G, 4G, GSM, 802.11). Input device 170 can comprise a keyboard, mouse, touchscreen, microphone, motion sensor, and/or other input device. Display device 180 can comprise an LCD screen, touchscreen, or other display.

Computing device 110 is coupled (by network interface 160 or another communication port) to data store 120 over network/link 190. Network/link 190 can comprise wired portions (e.g., Ethernet) and/or wireless portions (e.g., 3G, 4G, GSM, 802.11), or a link such as USB, Firewire, PCI, etc. Network/link 190 can comprise the Internet, a local area network (LAN), a wide area network (WAN), or other network.

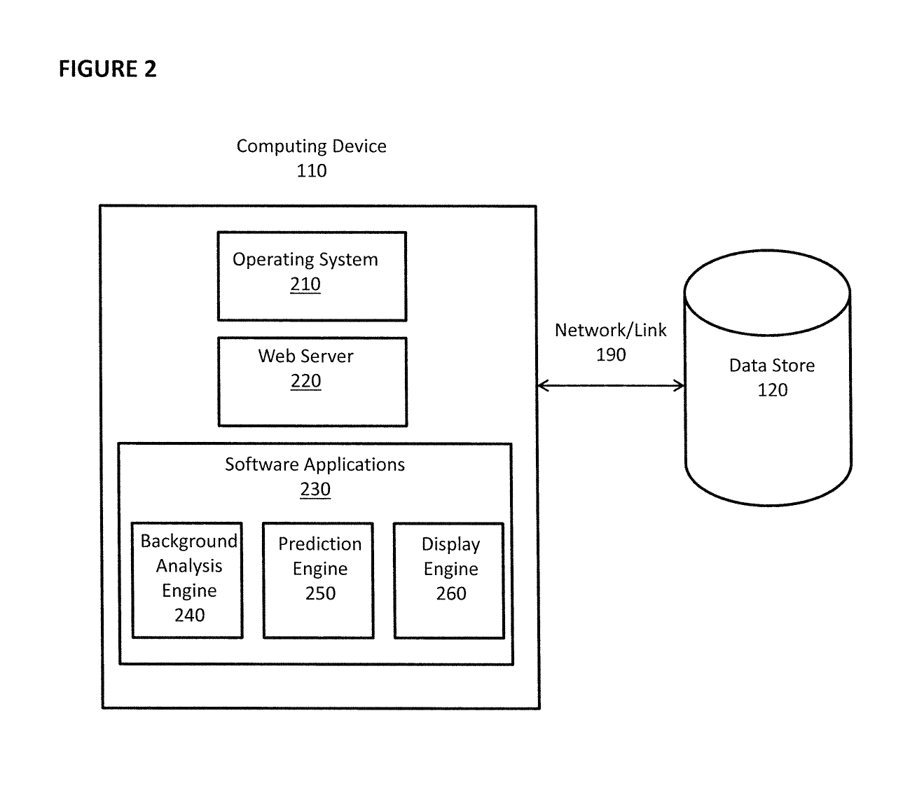

With reference to FIG. 2, software components of computing device 110 are depicted. Computing device 110 comprises operating system 210 (such as Windows, Linux, MacOS, Android, or iOS), web server 220 (such as Apache), and software applications 230. Software applications 230 comprise background analysis engine 240, prediction engine 250, and display engine 260. Operating system 210, web server 220, and software applications 230 each comprise lines of software code that can be stored in memory 140 and executed by processing unit 130 (or plurality of processing units).

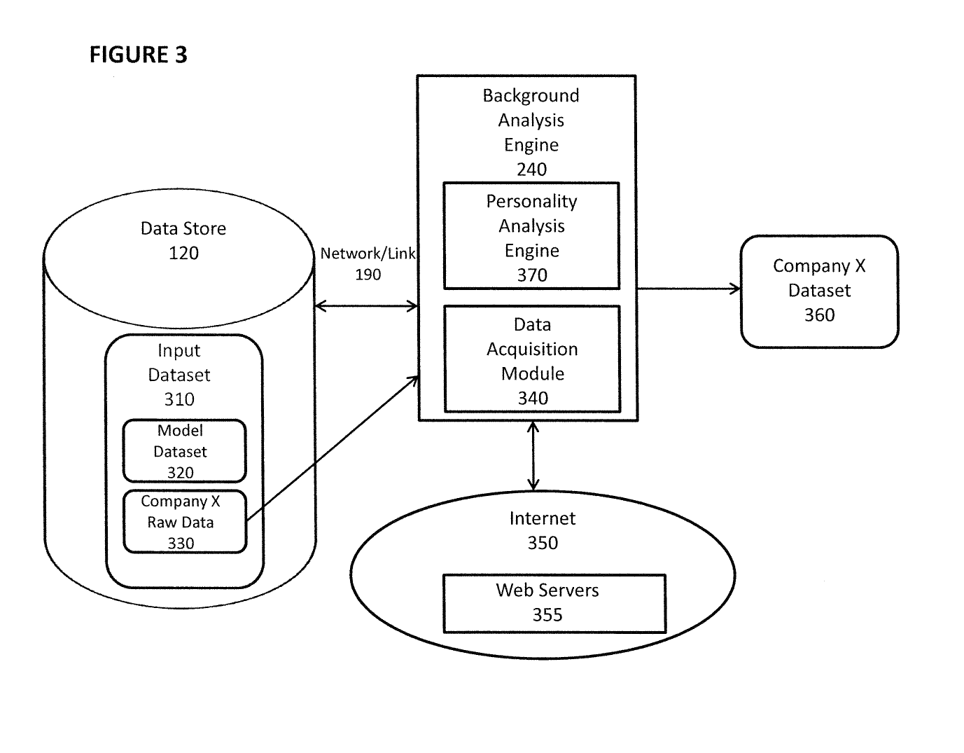

FIG. 3 depicts additional aspects of background analysis engine 240. In the examples that follow, it is assumed that the organization of interest is called “Company X.” Data store 120 contains input dataset 310. Input dataset 310 comprises model dataset 320 and Company X raw data 330. Company X raw data 330 includes data regarding Company X that might be input by a member of Company X at the start of the process, such as:
Location of Company X;
Names of founders, executives, Board members, and/or employees;
Schools from which the founders, executives, Board members, and/or employees graduated, locations of schools, rankings of schools;
Previous work experience of founders, executives, Board members, and/or employees;
Amount of capital raised by founders at previous companies;
Whether founders previously worked at multi-national companies;
Relevant industry;
Photographs and videos of founders, executives, Board members, and/or employees;
Pitch materials for Company X prepared by the founders; and
Other data.

Background analysis engine 240 comprises data acquisition module 340. Data acquisition module 340 will scour Internet 350 to find data regarding the founders, executives, Board members, and/or employees of Company X from data available from web servers 355 and other sources. Data acquisition module 340 can use screen scraping or other known data acquisition techniques. Data acquisition module 340 can obtain data, for example, from LinkedIn, facebook, Twitter, and other social media accounts; email accounts; blogs; business and industry websites; college and university websites; and other sites and data sources available on Internet 350.

Background analysis engine 240 further comprises personality analysis engine 370. Personality analysis engine 370 operates upon Company X raw data 330 and the data obtained by data acquisition module 340. Personality analysis engine 370 parses the collected text associated with the author and extracts word tokens n-grams (1-word, 2-word, 3-word, up to n-gram) terms after removing English stop-words and performing text stemming. The text is compared using an ensemble of machine learning algorithms (both regressions and classifiers) with a training database that includes other authors' textual content as well as the known personality traits of those authors. Personality traits can be classified using different schemes such as: the Myers Briggs Type Indicator (MBTI) personality types; the “big five” personality scheme; the Existence, Relatedness and Growth (ERG) motivation scheme created by Clayton P. Alderfer; Alderfer's other personality classification and motivation schemes; and other known schemes.

Personality analysis engine 370 generates Company X dataset 360, which includes data regarding attributes of the personalities of the founders, executives, Board members, and/or employees of Company X, such as:
Personality traits of founders:
   Openness, Adventurousness, Artistic interests, Emotionality, Imagination, Intellect, Liberalism, Conscientiousness, Achievement striving, Cautiousness, Dutifulness, Orderliness, Self discipline, Self efficacy, Extraversion, Activity level, Assertiveness, Cheerfulness, Excitement seeking, Friendliness, Gregariousness, Agreeableness, Altruism, Cooperation, Modesty, Morality, Sympathy, Trust, Neuroticism, Anger, Anxiety, Depression, Immoderation, Self consciousness, Vulnerability, Challenge, Closeness, Curiosity, Excitement, Harmony, Ideal, Liberty, Love, Practicality, Self expression, Stability, Structure, Conservation, Openness to change, Hedonism, and Self enhancement, and Self transcendence.
   Schools of Founders:
      School world rank, School excellence score, Country of the school, Impact score of the school.

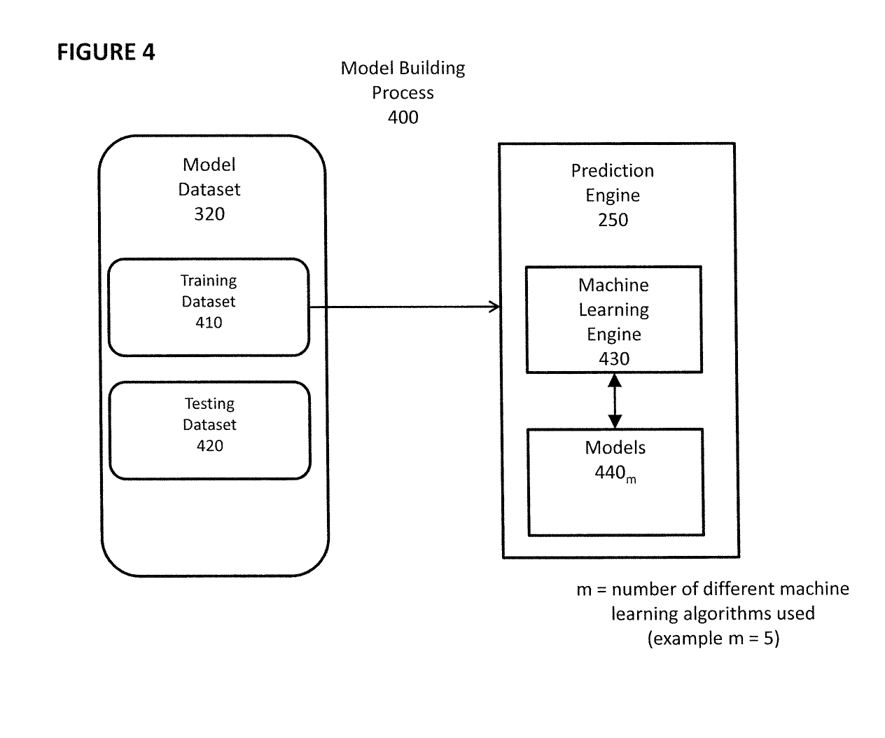

FIG. 4 depicts model building process 400. Model dataset 320 is split according to different splitting algorithms (such as random splitting, label-aware splitting, and splitting Based on the Predictors Clusters). Model dataset 320 comprises training dataset 410 and testing dataset 420. Training dataset 410 and testing dataset 420 each comprise data collected regarding established companies, where the data spans the entire lifecycle of the company from inception to the present. The data collected is similar in type to the data collected regarding Company X by data acquisition module 340 and contained in Company X raw data 330.

Prediction engine 250 receives training dataset 410. Prediction engine 250 comprises machine learning engine 430 and a plurality of models 440, ranging from model 440₁ to model 440ₘ, where m is the number of different machine learning algorithms used by prediction engine 250. Examples of machine learning algorithms include but not limited to GLM, RandomForest, eXtreme Gradient Boosting, Deep Believe Networks, Elastic nets, Multi-layer Neural Networks, Deep Boosting, Black Boosting, Evolutionary Learning of Globally Optimal Trees, and Rule- and Instance-Based Regression Modeling. Machine learning engine 430 uses training dataset 410 to create and refine models 440ₘ.

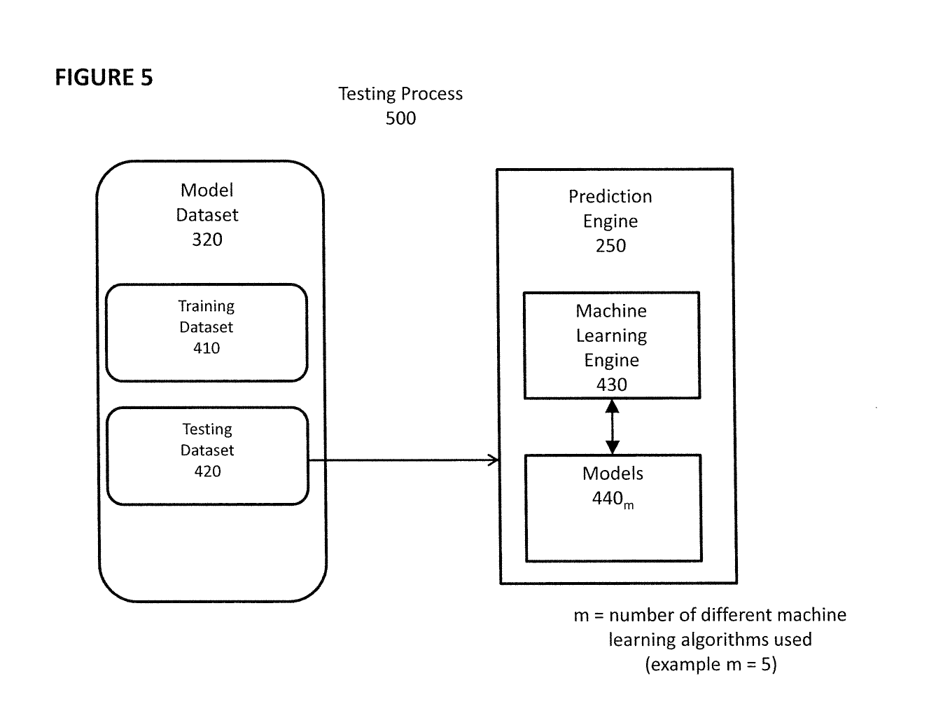

FIG. 5 depicts testing process 500. After models 440ₘ are created, prediction engine 250 receives testing dataset 420. Prediction engine 250 applies each of the m machine learning algorithms against data regarding the early stages of companies reflected in testing dataset 420 and compares the results of the machine learning algorithms against data regarding the later stages of the same companies. This allows prediction engine 250 to determine the accuracy of models 440ₘ. The process is repeated for all machine learning models (1 . . . to . . . m) and for different iterations of splits (1 . . . to . . . i).

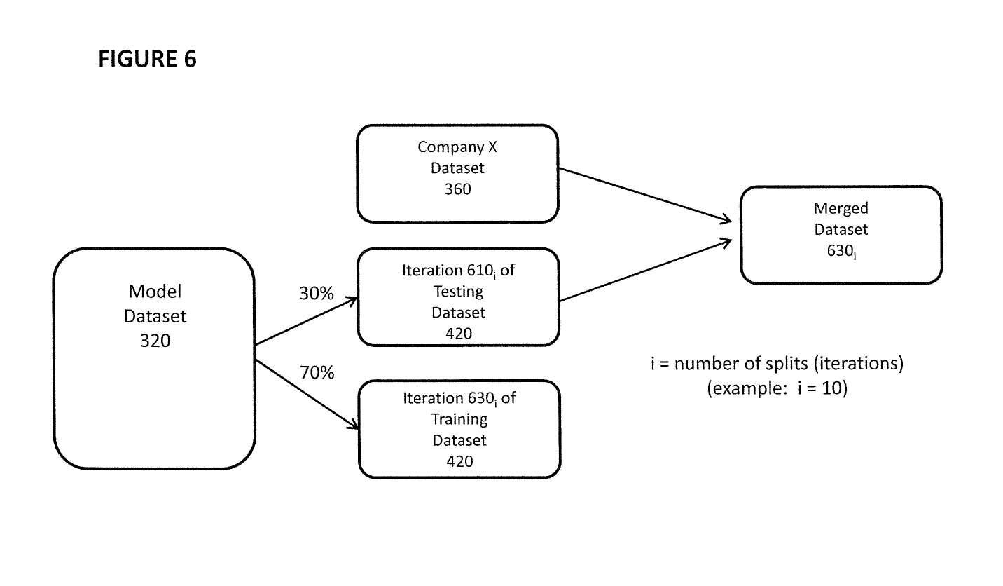

With reference to FIG. 6, Company X dataset 360 is combined with i different iterations 610i of testing dataset 420, where i is the number of subsets created. For example, if i is 10, then the model set is split randomly or according to a specific splitting algorithms mentioned above 10 times. For each split model data set 320 is split into iteration 610, of testing dataset 420 and iteration 630i of training dataset 420, in the ratio 70% and 30% or based on a split configuration file parameter. For each iteration, testing subset 610, is combined with company dataset 360 to created merged dataset 620ᵢ, such that there are i merged datasets created.

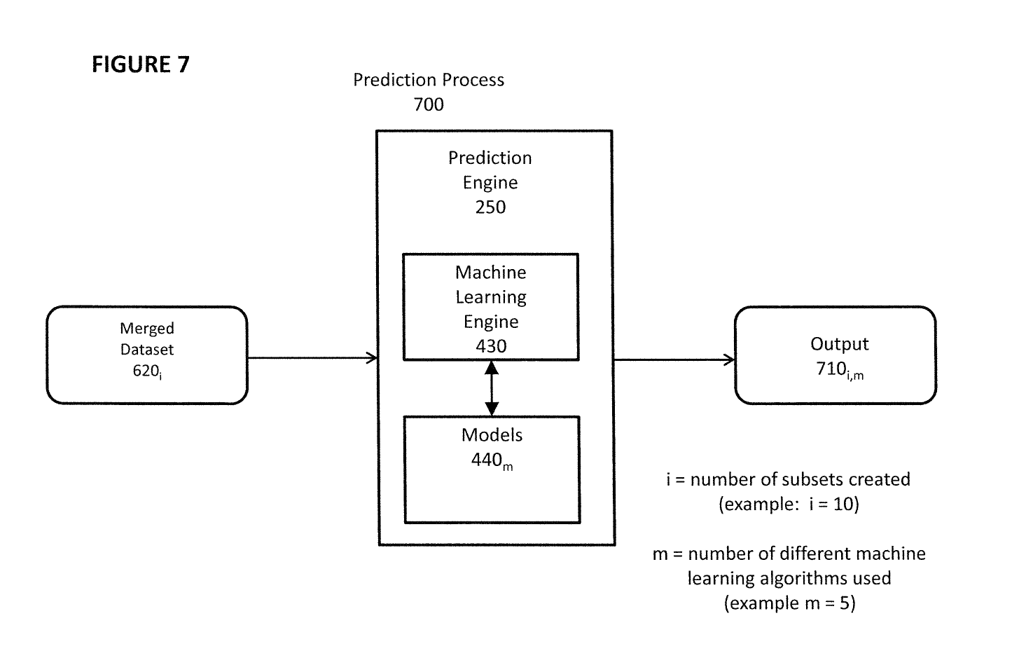

FIG. 7 depicts prediction process 700. Each merged dataset 620, is input to prediction engine 250. Prediction engine 250 runs each of the models 440ₘ against each of the merged datasets 620ᵢ to generate output 710_{i,m}. Thus, if i is 10 and m is 5, then 50 different outputs will be generated, output 710_{i,m} . . . output 710_{10,5}.

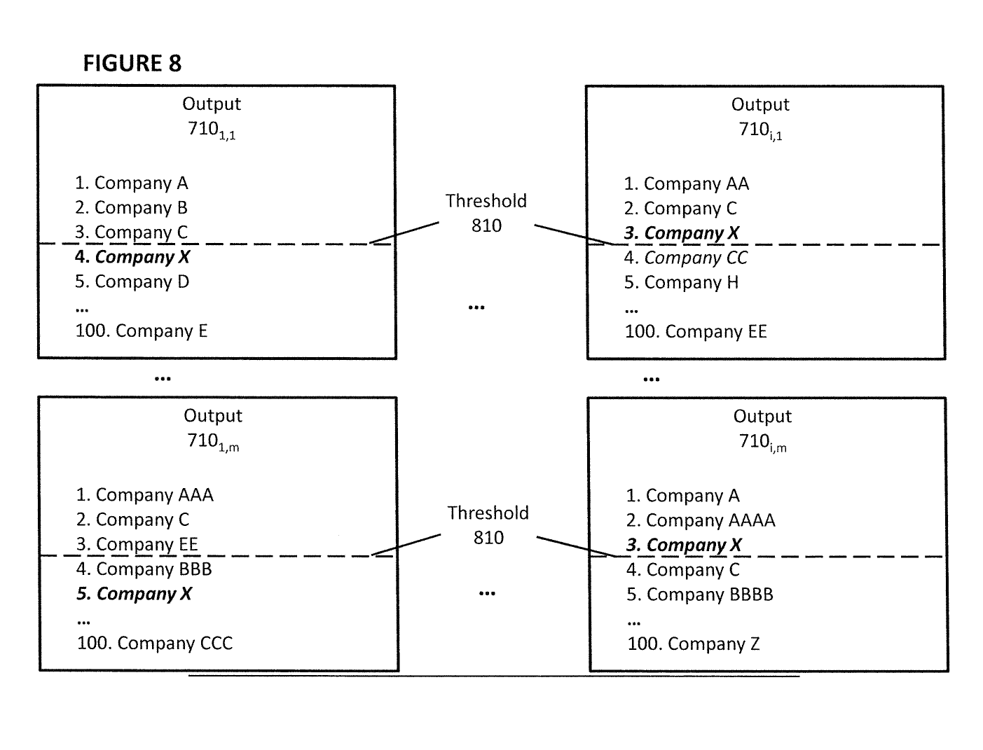

FIG. 8 depicts examples of output 710_{i,m}. Here, each output 710_{i,m} comprises a ranked listing of Company X and the companies contained in the merged dataset 620ᵢ. A threshold 810 can be selected by the user. Threshold 810 might be, for example, 1% or 3%. In this particular example, threshold 810 is selected to be 3%, where the inquiry of interest is how often Company X is in the top 3% of all companies contained in output 710_{i,m}.

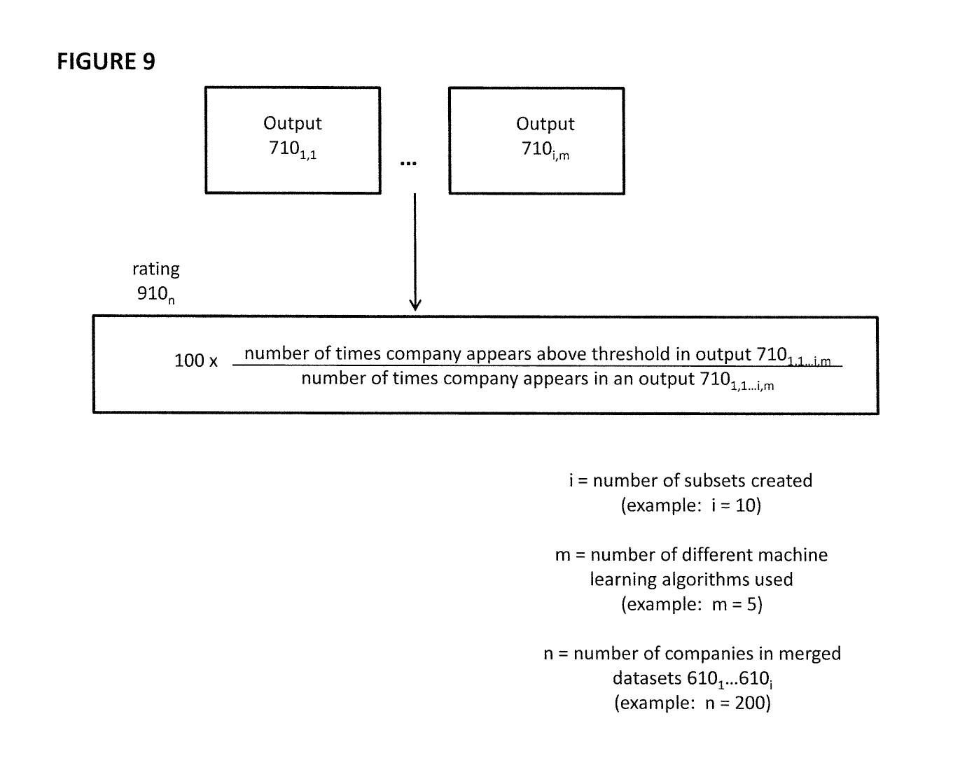

In FIG. 9, the outputs 710_{1,1} . . . 710_{i,m} are used to generate rating 910ₙ for each of the n companies reflected in merged datasets 620₁ . . . 620ᵢ, including Company X. Rating 910ₙ is the number of times the company appears above threshold 810 in outputs 710_{1,1} . . . 710_{i,m} divided by the number of times the company appears in output 710_{1,1} . . . 710_{i,m}, multiplied by 100. Because Company X dataset 360 is used in each of the merged datasets 620ᵢ, the denominator in the calculation to determine rating 910 for Company X always will be i. If Company A appears in, for example, 17 of the i merged datasets 620ᵢ, then the denominator for Company A will be 17.

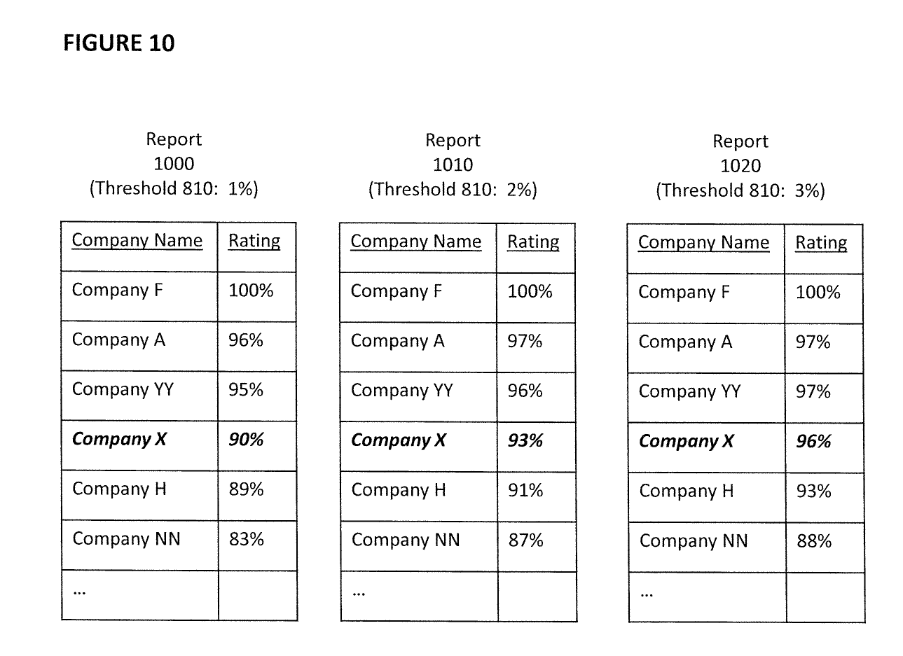

FIG. 10 shows exemplary report 1000 generated by display engine 260. Report 1000 shows rating 910 of all n companies (or a subset thereof), including Company X, for a certain threshold 810 applied, here 1%. This allows the user to see the relative strength of Company X against n well-established companies (or a subset thereof). It also allows potential investors to gauge the value of investing in Company X, as Company X likely will perform in a comparable manner to the companies listed near it on report 1000. Report 1010 is shown for threshold 810 equal to 2%, and report 1020 is shown for threshold 810 equal to 3%.

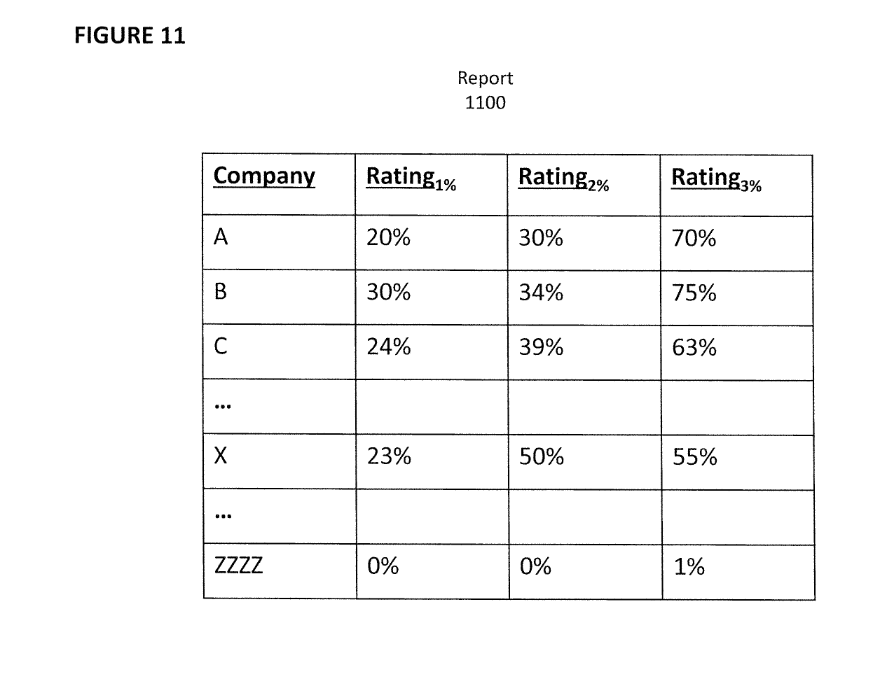

FIG. 11 shows another exemplary report 1100 generated by display engine 260. Report 1100 shows rating 910 for all n companies (or a subset thereof) and Company X. Report 1100 displays this data for a plurality of different thresholds 810. In this example, three values for threshold 810 are shown: 1%, 2%, and 3%. Thus, Company X appeared in the top 1% of companies in output 710_{i,m} 23% of the time; in the top 2% of companies in output 710_{i,m} 50% of the time, and in the top 3% of companies in output 710_{i,m} 55% of the time.

Applicants have tested the embodiments described above using real-world data and prototypes of background analysis engine 240, prediction engine 250, and display engine 260, and have rating 910ₙ to be a reliable predictor of the ultimate success of an early stage company. The embodiments will be a valuable tool in determining the likelihood of success of Company X and to identify existing companies that were comparable to Company X at the same stage of the company lifecycle.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between).

What is claimed is:

1. A method of calculating an expected success rate for a business entity using a computing device comprising a background analysis engine, a prediction engine, and a display engine, the method comprising:
receiving, by the background analysis engine, a model dataset and a first dataset;
acquiring, by the background analysis engine, a second dataset from a plurality of web servers;
processing, by the background analysis engine running one or more personality analysis algorithms, the first dataset and the second dataset to generate a third dataset;
splitting, by the prediction engine, the model dataset into i groups, each of the i groups comprising a training dataset and a testing dataset, using i splitting algorithms, wherein each of the i splitting algorithms generates one of the i groups;
adjusting, by the prediction engine running m machine learning algorithms, a set of models, wherein the adjusting occurs in response to each of the m machine learning algorithms operating on each training dataset in the i groups;
testing, by the prediction engine, the set of models using each testing dataset in the i groups and adjusting the second set of models based on the testing;
generating, by the prediction engine, i merged datasets, wherein each of the i merged datasets comprises the third dataset merged with a different testing dataset from the i groups; and
processing, by the prediction engine, the i merged datasets to generate i*m ranked lists, each of the ranked lists generated from one of the i merged datasets and one of the m machine learning algorithms and indicating the expected success of the business entity and other entities in the one of the i merged datasets.

2. The method of claim 1, further comprising:
applying p thresholds to the i*m ranked lists;

3. The method of claim 2, further comprising:
determining for each of the p thresholds the number of times the business entity appears above the threshold within the i*m ranked lists divided by the number of times the business entity appears in the i*m ranked lists to generate p ratings for the business entity, each of the p ratings associated with one of the p thresholds; and
determining, for each entity in the i*m ranked lists, for each of the p thresholds the number of times each entity appears above the threshold within the i*m ranked lists divided by the number of times the entity appears in the i*m ranked lists to generate p ratings for the entity, each of the p ratings associated with one of the p thresholds.

4. The method of claim 3, further comprising:
generating, by the display engine, a report showing, for at least one of the p thresholds, the threshold, the associated rating for the business entity, and the associated rating for one or more of the entities.

5. The method of claim 4, wherein the report displays the business entity and the one or more of the entities in order based on the associated ratings.

6. The method of claim 3, further comprising:
generating, by the display engine, a report showing, for all of the p thresholds, the threshold, the associated rating for the business entity, and the associated rating for one or more of the entities.

7. The method of claim 6, wherein the report displays the business entity and the one or more of the entities in order based on the associated ratings.

8. A computing device comprising a background analysis engine, a prediction engine, and a display engine, the computing device executing instructions to perform the following steps:
receive a model dataset and a first dataset;
acquire a second dataset from a plurality of web servers;
process, by running one or more personality analysis algorithms, the first dataset and the second dataset to generate a third dataset;
split the model dataset into i groups, each of the i groups comprising a training dataset and a testing dataset, using i splitting algorithms, wherein each of the i splitting algorithms generates one of the i groups;
adjust, by running m machine learning algorithms, a set of models, wherein the adjusting occurs in response to each of the m machine learning algorithms operating on each training dataset in the i groups;
test the set of models using each testing dataset in the i groups and adjusting the second set of models based on the testing;
generate i merged datasets, wherein each of the i merged datasets comprises the third dataset merged with a different testing dataset from the i groups; and
process the i merged datasets to generate i*m ranked lists, each of the ranked lists generated from one of the i merged datasets and one of the m machine learning algorithms and indicating the expected success of the business entity and other entities in the one of the i merged datasets.

9. The computing device of claim 8, the computing device further executing instructions to perform the following step:
apply p thresholds to the i*m ranked lists.

10. The computing device of claim 9, the computing device further executing instructions to perform the following steps:
determine for each of the p thresholds the number of times the business entity appears above the threshold within the i*m ranked lists divided by the number of times the business entity appears in the i*m ranked lists to generate p ratings for the business entity, each of the p ratings associated with one of the p thresholds; and
determine, for each entity in the i*m ranked lists, for each of the p thresholds the number of times each entity appears above the threshold within the i*m ranked lists divided by the number of times the entity appears in the i*m ranked lists to generate p ratings for the entity, each of the p ratings associated with one of the p thresholds.

11. The computing device of claim 10, the computing device further executing instructions to perform the following step:
generate, by the display engine, a report showing, for at least one of the p thresholds, the threshold, the associated rating for the business entity, and the associated rating for one or more of the entities.

12. The computing device of claim 11, wherein the report displays the business entity and the one or more of the entities in order based on the associated ratings.

13. The computing device of claim 10, the computing device further executing instructions to perform the following step:
generate, by the display engine, a report showing, for all of the p thresholds, the threshold, the associated rating for the business entity, and the associated rating for one or more of the entities.

14. The computing device of claim 13, wherein the report displays the business entity and the one or more of the entities in order based on the associated ratings.

15. A computing device comprising a background analysis engine, a prediction engine, and a display engine, the computing device executing instructions to perform the following steps:
receive a model dataset associated with a plurality of entities;
receive a first dataset associated with a business entity;
acquire, by the background analysis engine, a second dataset associated with the business entity from a plurality of web servers;
execute, by the background analysis engine and the prediction engine, personality analysis algorithms, splitting algorithms, and machine learning algorithms using the model dataset, first dataset, and second dataset as inputs to generate an output indicating the expected success of the business entity relative to one or more of the plurality of entities; and
display, by the display engine, a report based on the output.
